(19) United States
(12) Patent Application Publication
(10) Pub. No.: US 2008/0130152 A1
(43) Pub. Date: Jun. 5, 2008

(54) Manufacturing method of floating head, manufacturing method of storage device, and floating head inspecting apparatus

(75) Inventor: Masaki Kameyama, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,083

(22) Filed: Nov. 20, 2007

(30) Foreign Application Priority Data
Nov. 30, 2006 (JP) 2006-324863

(51) Int. Cl. G11B 27/36

(52) U.S. Cl. 360/31

(57) ABSTRACT

A method of manufacturing a floating head includes an inspecting step for inspecting performance of the floating head by simulating different environmental conditions, the inspecting step includes the steps of setting an electrical power to a heat generating material provided to the floating head to attain the flying height fluctuation predetermined for each environmental condition, projecting the head element in accordance with each environmental condition by driving the head element and feeding electrical power corresponding to each environmental condition preset in the setting step to the heat generating material, and inspecting performance of the floating head by changing the projecting condition.

### FIELD OF THE INVENTION

The present invention relates to a manufacturing method of floating heads used for a storage device such as a magnetic disk drive or the like, a storage device and a manufacturing method thereof and more specifically to a manufacturing method of floating heads for reducing influence on storing and read operations by flying height fluctuation of the floating head due to variation in air pressure and temperature or the like in the environment in which the storage device is used, a manufacturing method of a storage device, and a floating head inspecting apparatus.

### BACKGROUND OF THE INVENTION

In recent years, a magnetic disk drive is required, for further improvement in recording density, to reduce as much as possible and control more accurately the distance between the front end of the air flowing end of a head slider (or front end part of the head element) and the surface of a storage medium which is placed against the head slider, namely flying height of the head slider. However, the flying height of the head slider is influenced by change in the environment in which a magnetic disk drive is used, for example, by change in the temperature and the air pressure due to change in the altitude.

Particularly, the head slider is likely, to in contact a storage medium and a head crash is likely generated in the worst case, when the flying height is lowered due to the causes explained above.

Moreover, in recent years, a magnetic disk drive is remarkably reduced in size in addition to improvement in recording capacity explained above and the magnetic disk drive is therefore used in a variety of application ranges and application modes. Therefore, the magnetic disk drive is used not only in stationary installation type servers and personal computers but also in a portable type mobile apparatus such as a notebook type personal computer or a mobile telephone which may be used without selection of a single application area.

Accordingly, a magnetic disk drive is also required to normally operate even in various operating environments. Particularly, inspection of operations under the condition that environment temperature and air pressure are changed is considered extremely important.

Hence, in order to assure the normal operation within the predetermined operating range of the magnetic disk drive, for example, under the air pressure change corresponding to the altitude of 0 m to 5000 m or under the temperature change from 5° C. to 55° C., whether the magnetic disk drive can be operated normally has been verified by measuring change in the flying height of a head slider under the conditions explained above.

For example, as disclosed in Japanese Laid-open Patent Application Publication No. 1998-222945, whether the magnetic disk drive can be operated normally within the predetermined air pressure range is verified by measuring changing conditions of the read signal from the head slider while the air pressure is actually changed within a vacuum chamber.

Moreover, it is also inspected, using a vacuum chamber 1201 shown in FIG. 11, whether the magnetic disk drive can be operated normally by verifying a flying height of the head slider of the magnetic disk drive 1202 under the predetermined altitude and temperature using a controller 1205 under the conditions that temperature of inspection environment is varied using a heater 1203 in addition to generation of air pressure change using a vacuum pump 1204.

However, in the method explained above, the magnetic disk drive must be set, at the time of inspection in the manufacturing stage, in the inspection environment corresponding to various measuring conditions, for example, to the lower air pressure condition and high temperature condition. Therefore, inspection is impossible under the general environment such as temperature of 25° C. and air-pressure of atmospheric pressure as the normal temperature environment. Accordingly, it is required to use a large-scale inspecting facility using the vacuum chamber 1201 or the like shown in FIG. 11. In this case, the cost required for inspection is no longer negligible.

Moreover, the time required for inspection becomes longer because the inspection environment must actually be changed to the environment in accordance with various measuring conditions. Particularly, the inspection time required in some cases is several days for the inspection under a plurality of measuring conditions and for the inspection of a plurality of measuring areas.

In addition, the number of magnetic disk drives which may be inspected simultaneously is limited depending on capacity of the vacuum chamber 1201 and size of magnetic disk drive 1202 in the concept of the conventional inspection apparatus shown in FIG. 11. Therefore, in an example shown in FIG. 11, the eight magnetic disk drives 1202 (#01 to #08) can be inspected simultaneously. The method explained above is very inconvenient for simultaneous inspection of many magnetic disk drives explained above.

Moreover, in some cases, mounting accuracy of the head slider influences the manufacturing step of the magnetic disk drive on reduction in the flying height of the head slider required for realization of large capacity. That is, since differences are generated in accordance with the mounting accuracy of the head slider, the distance between each head slider and the storage medium, namely flying height of the head slider cannot always be attained as planned in the design step. Therefore, a constant margin must be provided in addition to the flying height to prevent contact between the head slider and the storage medium, this has hindered reduction in the flying height of the head slider.

Recently, flying height control of the head slider has been improved by the controlling of the distance (space) between the front end part of the head element of head slider and the storage medium layer of storage medium.

As explained above, since, the environment in which the magnetic disk drive is, spreading widely, it is also desirable to attain the optimum application condition by verifying the environmental conditions for the actual application of the magnetic disk drive.

Therefore, it is an object of the present invention to provide a manufacturing method for simultaneously inspecting many floating head sliders under the predetermined air pressure and temperature or the like within a short period of time without requiring the inspection facilities to actually change the air pressure and temperature over the predetermined ranges and also provide a low-price and high quality head slider which is assured in operations under various environments.

Moreover, it is an object of the present invention to provide a manufacturing method for setting the flying height of the head slider to the optimum value not depending on the mounting accuracy of individual head sliders. In addition, it is an object to provide a storage device which can be suitably used even if unexpected events such as external impact and vibration or the like occur.

### SUMMARY OF THE INVENTION

In order to achieve the objects explained above, the method of manufacturing a floating head including a head element for writing and reading data to and from a storage medium and a storage device including the same floating head includes an inspecting step for inspecting performance of the floating head in accordance with environmental conditions,

the inspecting step includes the steps of setting an electrical power feeding rate to a heat generating material provided to the floating head to attain the flying height fluctuation predetermined for each environmental condition (setting step), projecting the head element in accordance with each environmental condition by driving the head element and feeding electrical power corresponding to each environmental condition preset in the setting step to the heat generating material (projecting step), and inspecting performance of the floating head by changing the projecting condition (inspecting step).

The environmental conditions include at least one of air pressure, temperature, or humidity.

The head element includes a write element used to write data to the storage medium and the heat generating material includes the write element. Moreover, the head element includes a heater and the heat generating material also includes the heater.

In the projecting step, the head element is projected by driving the head element by feeding electrical power to the write element corresponding to the write operation and by feeding electrical power to the write element corresponding to each environmental condition. Or, the projecting step can be described in that the head element is projected by driving the head element in the power feeding rate to the write element during the write operation and power feeding rate to the heater during the write operation and moreover by feeding electrical power to the head in the power feeding rate corresponding to each environmental condition. Or, the projecting step can be in that the head element is projected by driving the head element in the power feeding rate to the head during the read operation and moreover by feeding electrical power to the heater in the power feeding rate corresponding to each environmental condition.

Accordingly, inspection can be conducted under the ordinary environment, because the environment similar to that of environmental condition can be established, namely emulated artificially, by controlling flying height without actual change of inspection environment of the floating head.

Moreover, the manufacturing method of storage device is characterized in that an electrical power feeding rate of heat generating material during drive of the head element is determined on the basis of the performance obtained by the inspecting step and the power feeding rate is stored in the storage device. Accordingly, the storage device for storing the optimum flying height not influenced by the mounting position error of the head can be realized.

In addition, the inspecting apparatus for inspecting performance of a floating head comprising a head element for writing and reading data to and from a storage medium includes a controller for inspecting performance of the floating head in accordance with environmental conditions. The control unit further includes a setting unit for setting an electrical power feeding rate to a heat generating material provided to the floating head to attain the floatation changing rate predetermined for each environmental condition, a drive and control unit for driving and controlling the head element to the projecting condition corresponding to each environmental condition by driving and controlling the head element and feeding electrical power in the feeding rate corresponding to each environmental condition preset with the setting unit to the heat generating material, and an inspecting unit for inspecting performance of the floating head by changing projecting condition with the drive and control unit.

Accordingly, since the environment similar to that of the inspecting condition can be established, namely emulated by controlling the flying height even when the inspecting environment of the floating head is not changed actually, inspection can be conducted in an ordinary environment.

The present invention is capable of providing a manufacturing method and an inspecting apparatus for simultaneously conducting the inspecting step of many floating heads within a short period of time under various environmental conditions without the necessity of a particular facility for conducting environment inspection such as air pressure inspection and temperature inspection. Accordingly, the present invention enables simplified selection of floating heads with higher accuracy and also enables high quality floating heads which are assured to under various environmental conditions. In addition, it is also possible to provide a highly reliable storage device which is assured in wider range of environments.

Moreover, higher storing density of the storage device can be realized and thereby still larger capacity can also be realized by setting a flying height of the floating head under the ordinary operation of the storage device to the optimum value not depending on the mounting accuracy of individual floating heads. In addition, it is therefore possible to provide a storage device which may be suitably used under the condition that unexpected event such as generation of impact and vibration or the like from the external side is generated.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a schematic diagram of a magnetic disk drive.

FIG. 2A is diagram showing the floating side of a head slider.

FIG. 2B is a side view of the head slider.

FIG. 3A is a diagram showing reduction in the flying height of the head slider.

FIG. 3B is a diagram showing an inspecting apparatus for inspecting performance of the head slider.

FIG. 4A is a diagram showing the relationship between altitude change and the flying height of the head slider.

FIG. 4B is a diagram showing the relationship between temperature change and the flying height.

FIG. 5A is a diagram showing the relationship between the electrical power fed to the heat generating material and head projection.

FIG. 5B is a diagram showing the relationship between the heat generation power dissipated in the heat generating material and projection.

FIG. 6A is diagram showing change of the flying height of the head slider due to actual altitude change.

FIG. 6B is another diagram showing change of the flying height of the head slider due to altitude change.

FIG. 7A is a diagram showing change of the flying height of the head slider due to temperature change.

FIG. 7B is a diagram showing change of the flying height of the head slider due to emulation.

FIG. 8A is a diagram showing change of the flying height of the head slider due to actual altitude change and temperature change.

FIG. 8B is a diagram showing change of the flying height of the head slider due to emulation.

FIG. 9 is a structural diagram of an inspecting apparatus.

FIG. 10 is a flowchart of the power setting process.

FIG. 11 is a concept diagram of the conventional inspecting apparatus.

### DETAILED DESCRIPTION

A floating head of a first embodiment of the present invention and a storage device using the same floating head will be explained below with reference to the accompanying drawings.

The floating head specified in the claims is defined as the head including a head suspension assembly and a head actuator arm assembly mounting a head slider or a head slider in this embodiment to the suspension thereof.

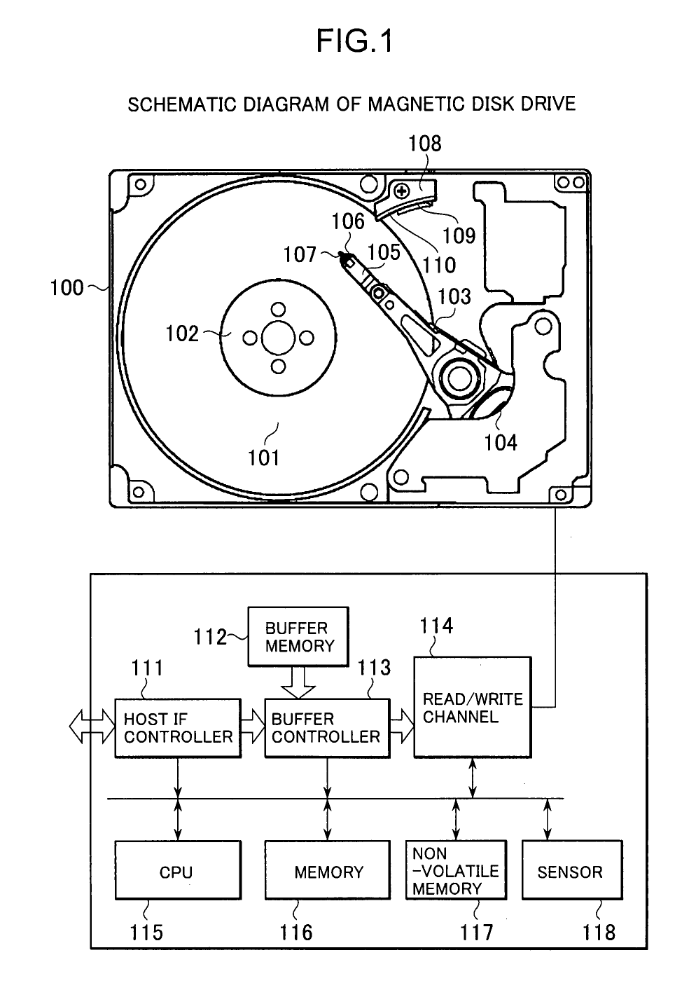

FIG. 1 is a schematic diagram of a magnetic disk drive. As shown in FIG. 1, a magnetic disk drive is accommodated in various structural members within a cabinet of almost a rectangular parallelepiped shape and the internal side of the cabinet is hermetically sealed from dust with the cover thereof (not illustrated) coupled with a cabinet 100.

A storage medium 101 is a magnetic disk as the storage medium for storing data. A magnetic layer is formed on a substrate as a storage medium layer. A spindle motor 102 drives the magnetic disk to rotate. An actuator mechanism 103 is coupled with a pivot extending in the vertical direction and is rotated around the pivot by a voice coil motor 104.

The actuator mechanism 103 is coupled, at the front end thereof, with a head suspension mechanism 105. A head slider 106 is pivotally supported at the area near the front end of the head suspension mechanism 105. The head suspension mechanism 105 supports the head slider 106 and also generates a predetermined force to press the head slider 106 toward the storage medium.

Moreover, the front end of the head suspension mechanism 105 is provided with a load tab 107 extending in the forward direction from the front end which is used for mooring the head slider 106 to a ramp mechanism 108 arranged at the circumferential edge of the magnetic disk drive.

The ramp mechanism 108 is mounted to the cabinet 100 using, for example, a screw and this ramp mechanism 108 is constituted with a mooring part 109 for mooring the head slider 106 to the predetermined location via the load tab 107 and a sliding part 110 for sliding operation with the load tab 107 when the head slider is drawn back toward the mooring part 109 from the area on the storage medium. The ramp mechanism 108 may be provided with a plurality of mooring parts 109 and sliding parts 110 in accordance with the number of head sliders 106 in the magnetic disk drive. The ramp mechanism 108 can be manufactured, for example, with the molding process using metal dies or the like from a hard plastic material and a resin material.

A block diagram of a control mechanism of the magnetic disk drive provided outside of cabinet 100 is shown in FIG. 1. A host interface controller 111 controls a host interface connected with a host apparatus. A buffer memory 112 stores data. A buffer memory controller 113 controls a buffer memory 112. A read/write channel 114 decodes data read from the storage medium 101 and encodes write data or the like. A microprocessor 115 controls the magnetic disk drive. A memory 116 develops and arranges control data and control program. A non-volatile memory 117 stores control program or the like.

Here, when data is transferred via the host interface, the transferred data is first stored in the buffer memory 112 via the host interface controller 111 and buffer controller 113. Thereafter, the data is written again into the storage medium 101 via the buffer controller 113 and read/write channel 114 in the timing preferable for the write process to the storage medium 101.

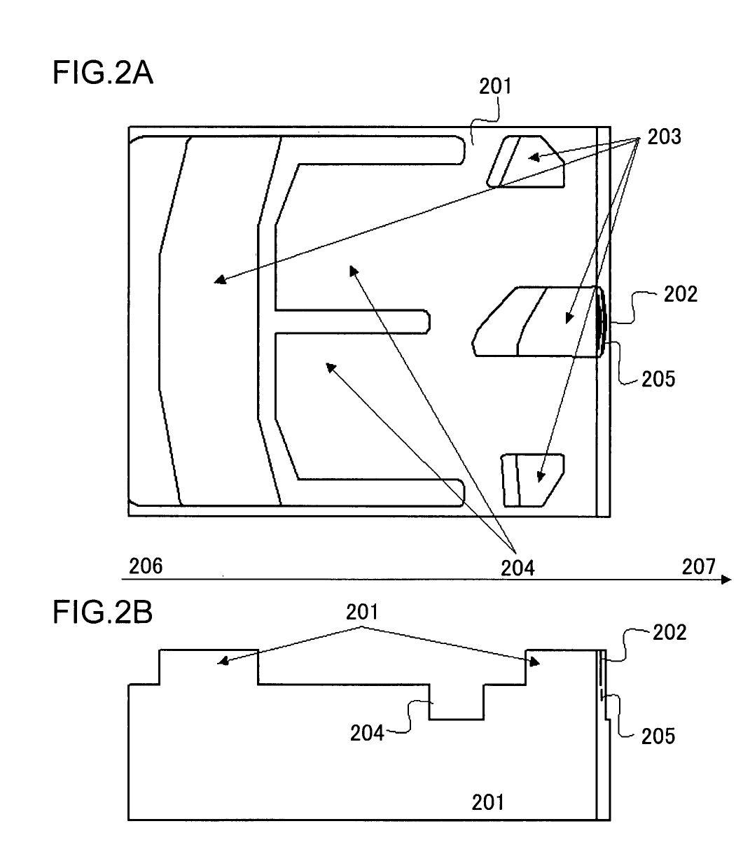

FIG. 2A is a diagram showing a floating plane of the head slider, while FIG. 2B is a side view of the head slider.

The head slider 106 is formed almost like the rectangular parallelepiped shape as shown in FIG. 2A and a slider body 201 is formed of the sintered material including Al, Ti, C called AlTiC. This head slider 106 is provided with a head element 202 at the predetermined location in the side of an air flowing end 206. Moreover, at the plane opposing the storage medium of the slider body 201, a plurality of rails are formed higher by a predetermined height and the slider body 201 is provided with a groove part 204 to generate negative pressure by expanding the air compressed with the ABS (Air Bearing Surface) planes 203 of the rails.

The head element 202 includes a read head element such as a GMR (Giant Magneto Resistive) element utilizing the magneto resistive effect for changing an electrical resistance in response to a magnetic field and a TMR (Tunnel Magneto Resistive) element utilizing the tunnel magneto resistive effect. The head element formed of an alloy such as NiFe or the like for writing data to the storage medium 101 by generating a magnetic field excited with a magnetic coil, and a protection film for protecting such thin films. Each element is arranged opposed to the medium plane at the air flowing end side on the floating surface of the head slider.

Here, a read head element utilizing the GMR element and TMR element is explained as an example, but the present invention is never limited only to such read head element and it is also possible to use other electromagnetic converting elements.

A heater 205 is a heat generating material arranged on the head element 202. When a thin film of the head element 202 thermally expands due to the heat generating effect thereof, the front end part of the head element 202 is projected by a predetermined distance toward the storage medium 101 (in the vertical direction to the floating plane) for the flying height control. Accordingly, a magnetic spacing between the write head element/read head element of the head element 202 and the magnetic layer of the magnetic disk can be controlled strictly. Moreover, where the heater 205 is arranged in the depth direction of the head slider in FIG. 2B is an example, but it is also possible to arrange the heater 205 in parallel with a thin film forming part of the electro-magnetic converting element in the longitudinal direction of the head slider.

Here, a magnetic coil of the write head element may also be used as a heat generating material in the present invention, but this heater 205 is not always required.

On the storage medium 101, air flow is generated as the storage medium 101 starts to rotate. When the head slider 106 moored to the ramp mechanism 108 is moved onto the storage medium 101, this air flow enters the forward side of the head slider, namely the air flowing end side 205.

Thereby, positive pressure, namely floating force and negative force are generated to the head slider 106 through the effects of the ABS planes of the rails and the groove part 204. When the floating force and negative pressure and the pressing force of the head suspension mechanism 105 are balanced, the head slider 106 is levitated with a comparatively higher rigidity during rotation of the storage medium 101.

In addition, when the actuator mechanism 103 starts rotating operation, it rotates the head slider 106 across the storage medium 101 and the head element provided on the head slider is positioned to the predetermined location for the data read/write operations.

When the head element is driven to write data, the write head element/read head element located at the front end part of the head element and the protection films around these heads are projected with the heat generating effect caused by feeding power to the write head element in the head element 202 and to the heater 205 located at the area near the write head element. Thereby, the distance between the storage medium 101 and the front end part of the head element is reduced so that these elements come closer to each other. Similarly, even during the data read drive of the head element, the write head element/read head element located at the front end part of the head element and the protection films around these elements are projected by the heat generating effect due to feeding power to the heater 205 and thereby the distance between the storage medium 101 and the front end part of the head element is reduced so that these elements come closer to each other.

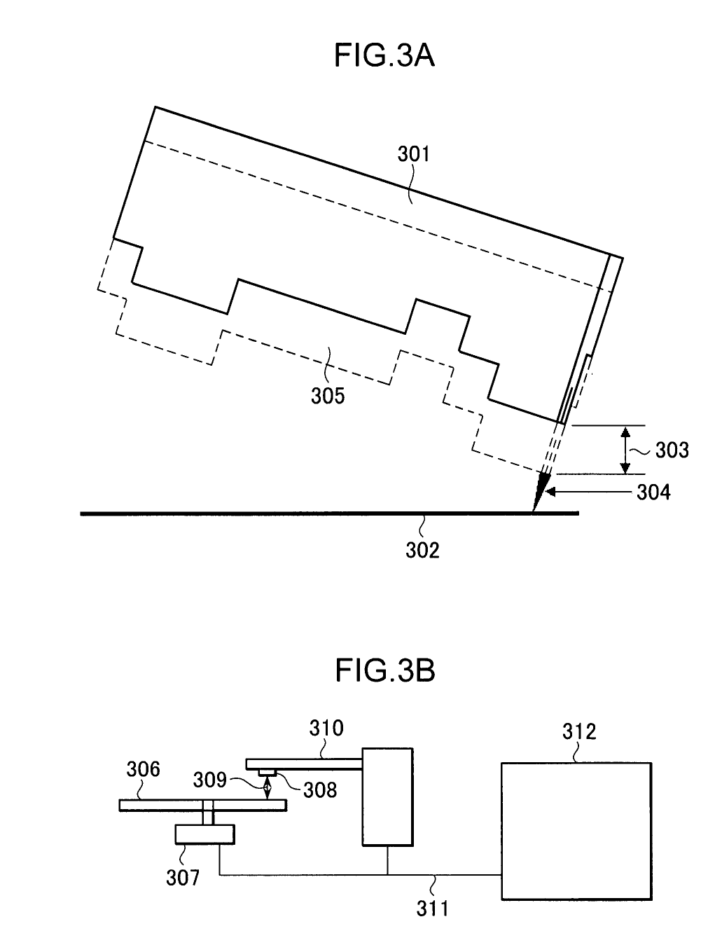

Accordingly, when a flying height from the storage medium 302 of the head slider 301 is reduced by the flying height difference 303 as shown in FIG. 3A because the ambient environment of the magnetic disk drive changes, the floating state of the head slider changes to the state 305 indicated by a dotted line. If projection 304 occurs while the head element is driven under the state mentioned above, collision with the storage medium 302 is likely generated.

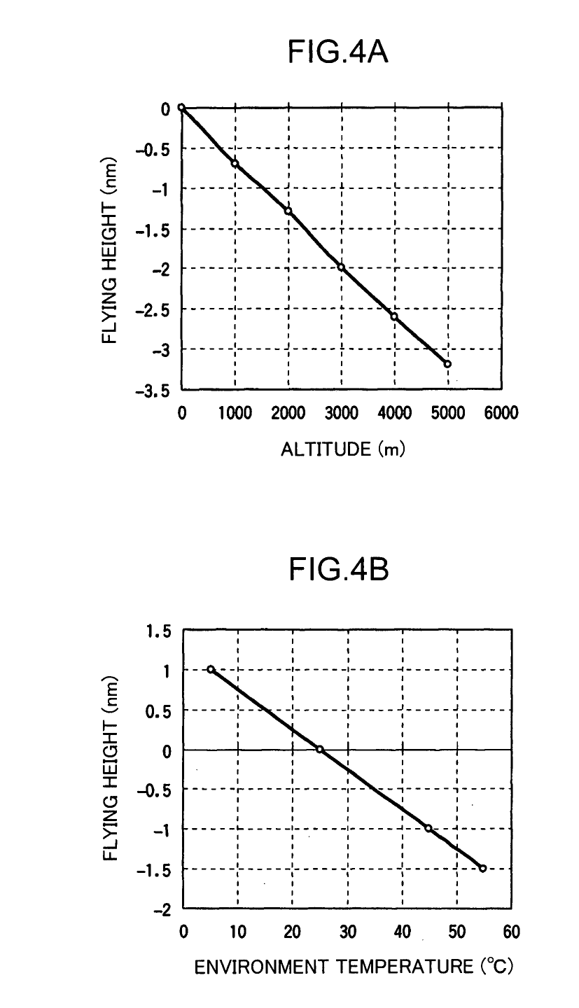

FIG. 4A and FIG. 4B are diagrams showing change in the flying height of the head slider 106 due to change in the ambient environment of the magnetic disk drive. FIG. 4A is a graph showing the relationship between temperature change and flying height. Namely, this graph shows that as the altitude where the magnetic disk drive is used increases, the flying height of the head slider 106 drops due to decrease of air pressure. Altitude is plotted on the horizontal axis and reduction of flying height from that when the altitude is 0 m is plotted on the vertical axis. As is apparent from the drawing, reduction rate changes almost linearly in the range where the magnetic disk drive can be used, in this case, in the range of 0 m to 5000 m.

FIG. 4B is a graph showing the relationship between temperature change and flying height. Namely, this graph shows change in the flying height of the head slider due to temperature change in the environment where the magnetic disk drive is used. Temperature is plotted on the horizontal axis, while increase/decrease from the reference value of the flying height under the normal temperature of 25° C. is plotted on the vertical axis. In this case, the height changes also almost linearly in the range where the magnetic disk drive is used, in this case, in the range of 5° C. to 55° C. The reference value of the flying height may be set with reference to 5° C. which is the lowest point in the available range.

As explained above, since the flying height of head slider 106 changes almost linearly, namely the gradient in change of flying height is almost constant even in any case explained above, the flying height of the head slider 106 at the desired point can be computed easily by utilizing the increase/decrease rate of the flying height of the head slider 106, for example, at a plurality of temperatures or air pressures. Similarly, the flying height of the head slider 106 at the desired point can be obtained easily through linear approximation using a linear expression by utilizing increase/decrease rate and the gradient of change of the flying height in a certain temperature or air pressure.

Accordingly, the inventors of the present invention have found that flying height can be set virtually by changing the distance between the storage medium 101 and the head element 202.

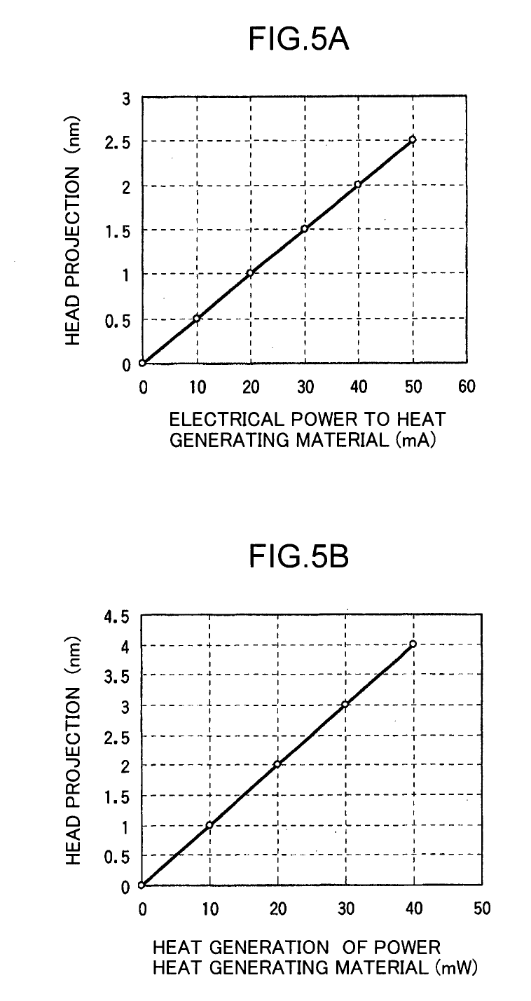

FIG. 5A and FIG. 5B are graphs for explaining the relationship, for example, between electrical power fed to the heater or heat generating material such as, the write head element or heat generating rate of the heat generating material and the projection distance of the head element 202.

FIG. 5A is a graph showing the relationship between electrical power fed to the heat generating material and projection distance. Electrical power to the heat generating material is plotted on the horizontal axis and projection height on the vertical axis. As is apparent from the drawing, when the power increases, projection distance also increases linearly.

Moreover, FIG. 5B is a diagram showing the relationship between heat generating power dissipated by the heat generating material and projection distance. Heat generating power is plotted on the horizontal axis and projection distance on the vertical axis. Since heat generation is proportional to the electrical power feeding rate, when the heat generating power increases, the projection distance also increases almost linearly in accordance with increase of the heat.

Therefore, since the projection rate of the area near the front end of the head element 202 due to the work of the heat generating material changes almost linearly, the projection rate of the head element 202 at a certain point can be computed easily, like the change of the flying height of the head slider shown in FIG. 4, by utilizing values of the horizontal axis at a plurality of points and the projection heights of the head element 262 at these points and also utilizing a value of a certain point and a gradient of change.

From the above results, a current value fed to the heat generating material can be obtained easily by obtaining flying height fluctuation at the air pressure or temperature to be inspected and then obtaining amount of electrical power required for generation of the projection amount corresponding to the flying height fluctuation from FIG. 5A on the basis of FIG. 4A or 4B.

Therefore, change in the flying height of the head slider corresponding to change of environment such as air pressure and temperature can be emulated by utilizing change in the projection rate of the front end part of the head element 202 in the ordinary environment similar to the normal temperature and normal air pressure (for example, when the atmospheric pressure under the temperature of 25° C. is defined as the standard environment).

In other words, the flying height of the head slider can be set in the inspecting condition by controlling the distance between the front end part of the head element of the head slider 106 and the front surface of the storage medium 101. Therefore, it is possible to virtually generate the floating state of the head slider 106 occurring under a certain air pressure or temperature and to measure performance of the head slider under the standard environment.

FIG. 3B shows an example of the inspecting facility for inspecting performance of the head slider. A medium 306 for inspection is used for inspection of the floating state of the head slider. A drive means 307 supports and drives the inspection medium to rotate. A head slider 308 is an object for inspection of floating state. The flying height of the head slider is defined as 309. A supporting means 310 supports the head slider to the predetermined state. A controller 312 controls the drive means and supporting means via a communication line 311 and also conducts the process for emulating the flying height corresponding to the predetermined environmental condition by generating projection by conducting the power feeding process to the write head element of the head slider or the like.

Moreover, the controller 312 of the floating head inspection apparatus executes the inspection process, and includes a setting unit for setting an electrical power feeding rate to the heat generating material provided to the floating head to obtain the flying height changing rate predetermined for each environmental condition corresponding to the controller for inspecting performance of the floating head in accordance with the environmental condition, a drive and control unit. The drive and control unit conducts drive and control operations by conducting the drive and control operations (i.e., the write and read operations) at the head element to the magnetic storage device or the floating head, feeding electrical power in the power feeding rate corresponding to each environmental condition preset by the setting unit to the heat generating material, and projecting the head element in the projecting state corresponding to each environmental condition, and a processing function or a program corresponding to the inspecting unit for inspecting performance of the floating head by changing the projecting state with the drive and control unit. The floating head inspecting apparatus may also be provided with a display unit such as a display for outputting a series of processing results or the like and an input unit such as keyboard and mouse. Moreover, the structure of this invention is capable of repeatedly conducting the performance inspection by changing the projecting state in accordance with the number of environmental conditions for inspection.

A flying height inspection is executed before the head slider is built into the magnetic disk drive by placing the head slider above the inspection medium used for inspection of floatation of the head slider, as will be explained below in detail as an example. The present invention is never limited only to such inspection mode and the inspection can also be conducted under the condition that the head slider and storage medium are built into the magnetic disk drive.

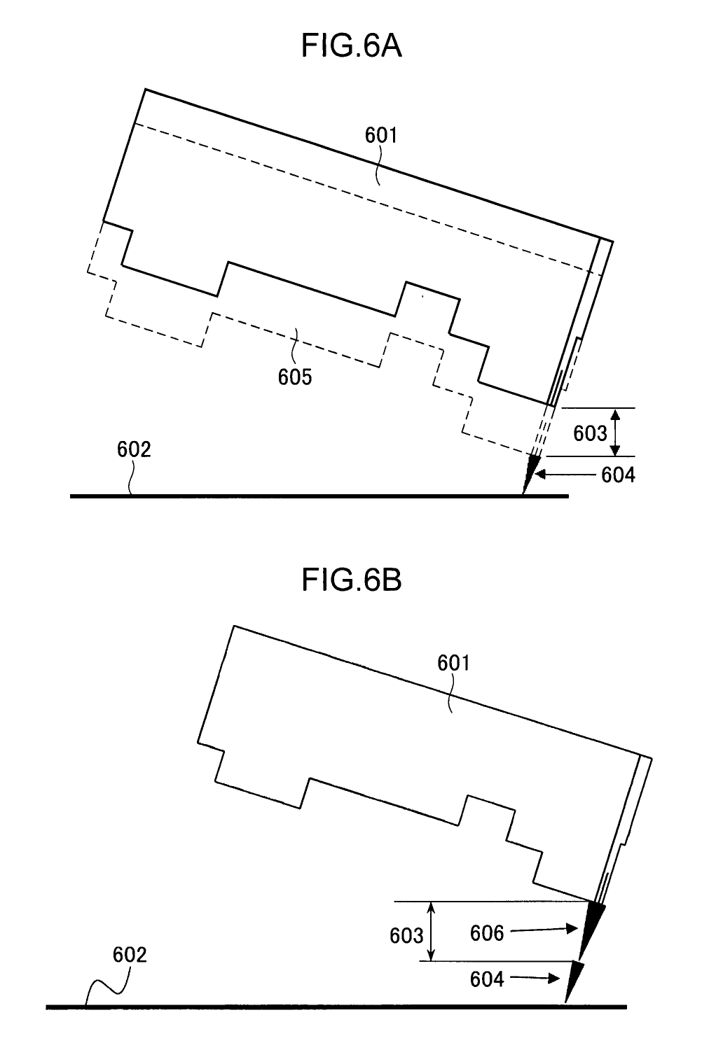

The inspection process for flying height of the head slider on the basis of each condition with reference to FIG. 6 to FIG. 8 will be explained below in detail. FIG. 6 is a schematic diagram for inspection of floatation performance to check whether the head slider is likely to be in contact with the storage medium 101 when the head element is operating under the air pressure condition corresponding, for example, to the altitude of 3000 m (assuming the use in a higher mountain or in an air-craft).

As shown in FIG. 6A, when the air-pressure becomes low for the standard environment, the head slider 601 changes to the location 605 indicated by a dotted line through reduction of the flying height thereof. In this case reduction 603 of flying height is about 2 nm when FIG. 4A is considered. Accordingly, the distance between the head slider 601 and the storage medium 602 is reduced as much as such reduction rate.

Reduction rate of the distance between the front end part of the head element of head slider 601 (part opposing to the disk) and the front surface of the storage medium 602 is simulated by changing the projection rate of the head element. The electrical power feeding rate for inspection to realize the projection rate 606 corresponding to 2 nm under the normal air pressure can be easily obtained as 40 mA from FIG. 5A. A changing rate of the projection rate and flying height can be determined with previous measurements because the specification is almost the same head slider. Namely, as shown in FIG. 6B, a projection amount is set to the projection distance obtained by adding a projection distance 606 corresponding to the change in flying height corresponding to environmental change and a projection amount 604 during ordinary write operations in a standard environment (normal temperature and normal air pressure).

Accordingly, for emulation of reduction in the flying height of a head slider during the flying height inspection for the head slider due to change of air pressure, it is enough that additional electrical power is fed in addition to the electrical power feeding rate for inspection obtained with the method explained above by previously obtaining the electrical power feeding rate for write process under standard environment determined suitably in the design stage to feed the electrical power to the head element for inspection during the write operation.

Moreover, as shown in FIG. 6B, it is possible to inspect whether the flying height of the head slider is adequately acquired as the design value by detecting that the storage medium 602 is not in contact with the head element 202 with a shock sensor (for example, piezoelectric element) mounted to the supporting mechanism while the writing operation is conducted under the condition that projection 604 caused by the current for write operation and projection 606 caused by the current for inspection are generated. Moreover, whether data has been written when the head element is in contact with the storage medium can be detected by monitoring, in addition to detection of contact with the shock sensor, change in the read amplitude and generation of error. That is, the contact state can be detected from the read signal because off-track is generated and writing of data is skipped because of contact between the storage medium and head element.

In addition, in the case of the head slider including the heater 205, it is enough that electrical power feeding rate (and projection rate) to the heater for write operation under the standard environment, suitably determined in the design stage or the like, is obtained previously and the electrical power is fed to the heater for inspection in addition to the power fed to the heater for write operation.

Moreover, data for checking the performance (special data is not required and ordinary data may be used) is written into the storage medium. In addition, electrical power feeding rate to the heater for read operation under the standard environment is previously determined to provide the projection height equal to that during the write operation under the standard environment. Next, the data written into the storage medium is read by controlling the power feeding rate to the heater for read operation and the power feeding rate to the heater for inspection in order to obtain the projection rate identical to that during the write operation considering change in the environment. Contact state can be detected with the detecting method using characteristic of the read signal indicating that the read signal increases in amplitude when thermal asperity is detected or when the head element 203 comes close to the storage medium and when the head element 202 is in contact with the storage medium, the read signal is saturated and no longer increases. Here, it is also permissible that contact is detected by reading the data written into the storage medium through control of the electrical power feeding rate to the heater for read operation and the electrical power feeding rate to the heater for write operation after the data for checking performance is previously stored on the storage medium.

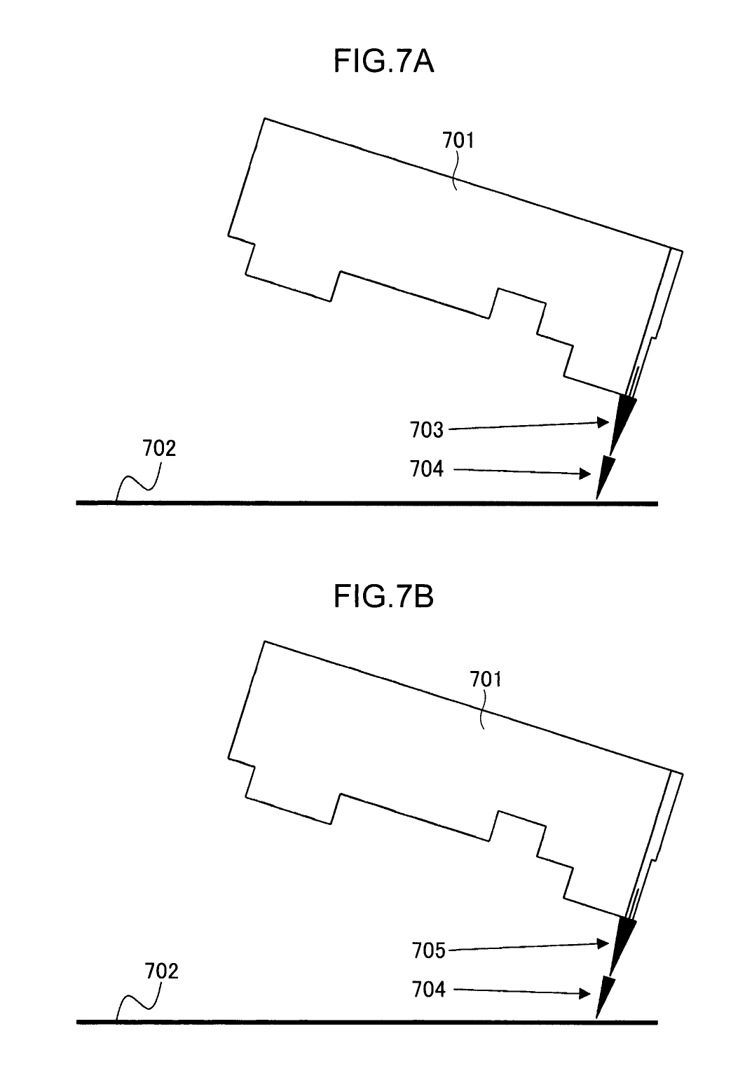

FIG. 7A and FIG. 7B are schematic diagrams showing change in the flying height of the head slider accompanied with change of temperature from the standard environment. For example, it is expected that the magnetic disk drive operates normally when the environment temperature is 55° C., so the floatation performance as to whether the head slider is in contact with the storage medium 101 or not during operation of the head element 202 is inspected.

When temperature becomes high, the distance between the head element and the storage medium 702, namely the flying height, is reduced because the head element is projected toward the storage medium 702 as much as the projection rate 703 as shown in FIG. 7A. The projection rate 703 in this case can be lowered as much as about 1.5 nm when FIG. 4B is considered.

Moreover, the electrical power feeding rate to realize the projection amount 705 of the head element corresponding to reduction of the distance between the head slider 701 and storage medium 702, namely 1.5 nm at the normal temperature, can be easily obtained as 30 mA from FIG. 5A.

That is, total projection is set, as shown in FIG. 7B, to the value obtained by adding respectively the projection rate 705 corresponding to the changing rate of flying height depending on change of environment when the air pressure is set to normal pressure (atmospheric pressure) and only temperature is changed and the projection rate 704 in the ordinary write operation under the standard environment (normal temperature and normal air pressure).

Therefore, whether the flying height of the head slider is within design specification can be determined easily even with respect to floatation performance due to temperature change, and with respect to floatation performance due to air pressure change, by superimposing electrical power superimposing on the power feeding rate for inspection obtained with the method explained above, in addition to the power feeding rate for the predetermined write operation applied to the head element for write operation during the write operation under the standard environment, in order to detect that the storage medium 702 is not in contact with the head element projected by the effect explained above.

In addition, an example where the current of 30 mA for emulating a changing rate of the flying height of head slider is fed superimposing on the write operation current is explained but in the case of the head slider comprising the heater, contact state can be detected by controlling the projection rate through control of the predetermined electrical power feeding rate to the heater for write operation or electrical power feeding rate to the heater for read operation and the electrical power feeding rate to the heater for inspection as in the case of the air pressure inspection explained above.

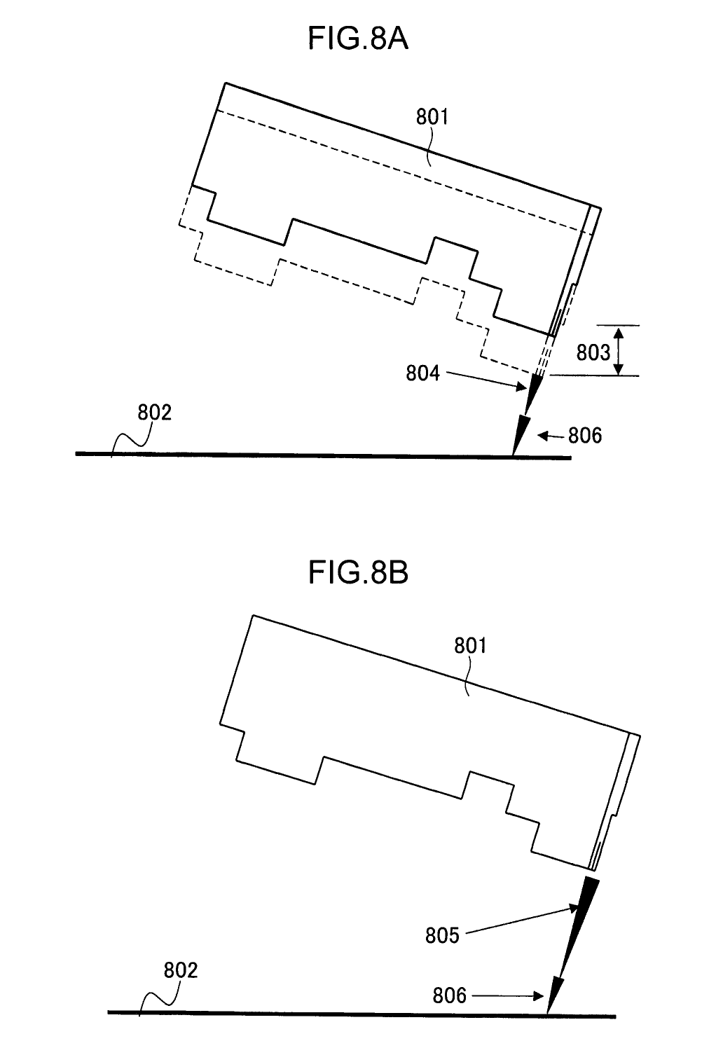

FIG. 8A and FIG. 8B are schematic diagrams showing changes in the flying height of a head slider accompanied by changes in the altitude and temperature from the standard environment. For example, in the case where the altitude is 3000 m and environment temperature is 55° C., whether the head element of the head slider 801 is in contact with the storage medium 802 during operation is inspected.

Since the changing rate 803 of flying height of head slider due to air pressure and the changing rate 804 of flying height of head slider due to temperature change linearly and these are not functionally related to each other as shown in FIG. 8A, a changing rate of the flying height of head slider 801 can be obtained by simply adding the changing rates (803, 804) of flying heights resulting from respective reasons.

Accordingly, since the projection rate corresponding to the changing rate of flying height of head slider 801 can be obtained as the simply added projection rate 805 as shown in FIG. 8B, the added current value corresponding to respective projection rate can be fed to the heat generating material.

More specifically, it is enough when the head element is projected as much as the value, namely 3.5 nm which can be obtained by adding the changing rate 2 nm of flying height corresponding to the altitude 3000 m and the projection rate 1.5 nm of the head element when the environment temperature is 55° C. Accordingly, a changing rate of flying height due to temperature change can be emulated by feeding the current of 70 mA equal to the added value of 30 mA and 40 mA.

Therefore, whether the flying height of head slider 801 is within design specification can be inspected easily as the inspection of floatation performance by detecting that the storage medium 802 is never in contact with the head element 202 through application of current previously obtained by the method explained above, in this case, 70 mA, additionally superimposing on the predetermined current value fed to the write head element during the write operation as in the case of the inspection when the altitude changes and the inspection of flying height of head slider due to temperature change.

Moreover, in the case of head slider comprising, at the head element, the heater for projecting the front end part of the head element, contact state can be detected by controlling the projection rate through control of the predetermined power feeding rate to heater for write operation or power feeding rate to heater for read operation and the power feeding rate of heater for inspection as in the case of the air pressure inspection and temperature inspection.

As explained above, according to the first embodiment of the present invention, environment for inspection of flying height of the head slider can be emulated easily only by controlling the flying height of the part nearest to the storage medium (front end part of head element of the air flowing end part) under the condition that the head slider is levitated by feeding the electrical power to the write head element or the heat generating material such as heater. Accordingly, the inspection for flying height of head slider can be realized easily and economically because a large scale inspection facility such as a vacuum chamber is not required.

Moreover, since a vacuum chamber is not actually required, the vacuum chamber is not required to be set to the evacuated state using a vacuum pump. Therefore, the time required for inspection can be reduced to a very short period of time. More specifically, the inspection time for a single inspection area can be reduced only to several seconds and the inspection which is required for a plurality of inspection points on the storage medium can also be completed within several minutes. Particularly, if inspections are required under a plurality of conditions, for example, altitude is selected as 0 m, 1500 m, and 3000 m or the like, the inspection can be executed within a short period of time like the measurements of a plurality of points under the equal condition only by changing the electrical power feeding rate.

In addition, the inspection can also be executed simultaneously for a plurality of head sliders because inspection is never subjected to limitation in the capacity of vacuum chamber and size of head slider or the like.

Accordingly, the present invention can provide the effect that high quality and low price head slider assuring operations under various environments can be provided easily.

The environment inspection explained above can also be implemented in the inspection step of the final stage in the manufacturing process of head slider and head suspension assembly by temporarily fixing the suspension mounting the head slider to the disk drive for inspection as the discrete inspection of the head slider and head suspension assembly. Moreover, the environment inspection can also be applied to the pre-step for assembling the magnetic disk drive, namely to the inspection step after the manufacturing step where the assembling has been progressed up to the state of actuator arm assembly mounting the head suspension assembly. Moreover, the environment inspection explained above can also be applied to the inspection step after assembling of the magnetic disk drive.

The performance inspection step includes not only the inspection of contact inspection and floatation inspection explained above but also the inspection step such as electromagnetic conversion performance of head element, recording and read performance, and overwrite characteristic under various environment conditions, operation verifying inspection step and various adjustment and inspection steps. The performance inspection step of the present invention can be applied to these inspection steps. Moreover, inspection with respect to air pressure and temperature has also been explained above but humidity can also be set as the inspection condition. As the inspection for humidity change, the inspection for touch-down characteristic of head slider which varies depending on the moisture adhered to a storage medium can be considered.

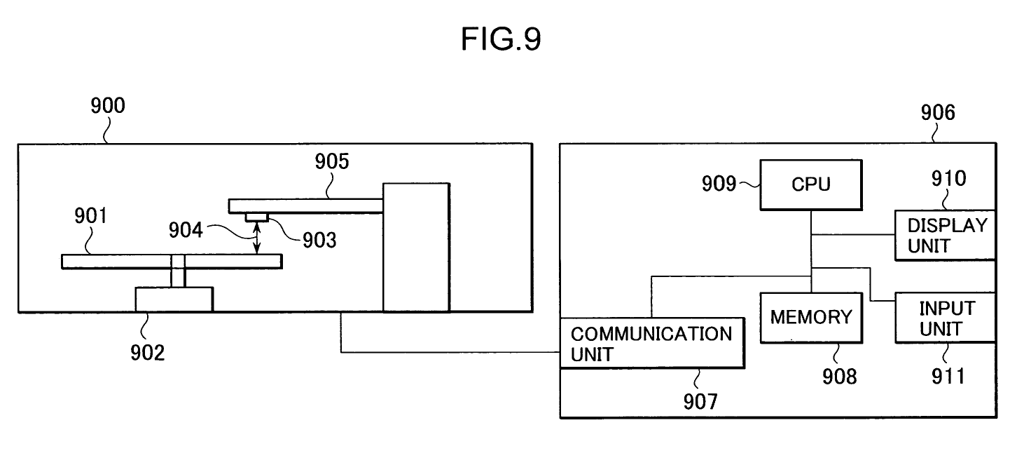

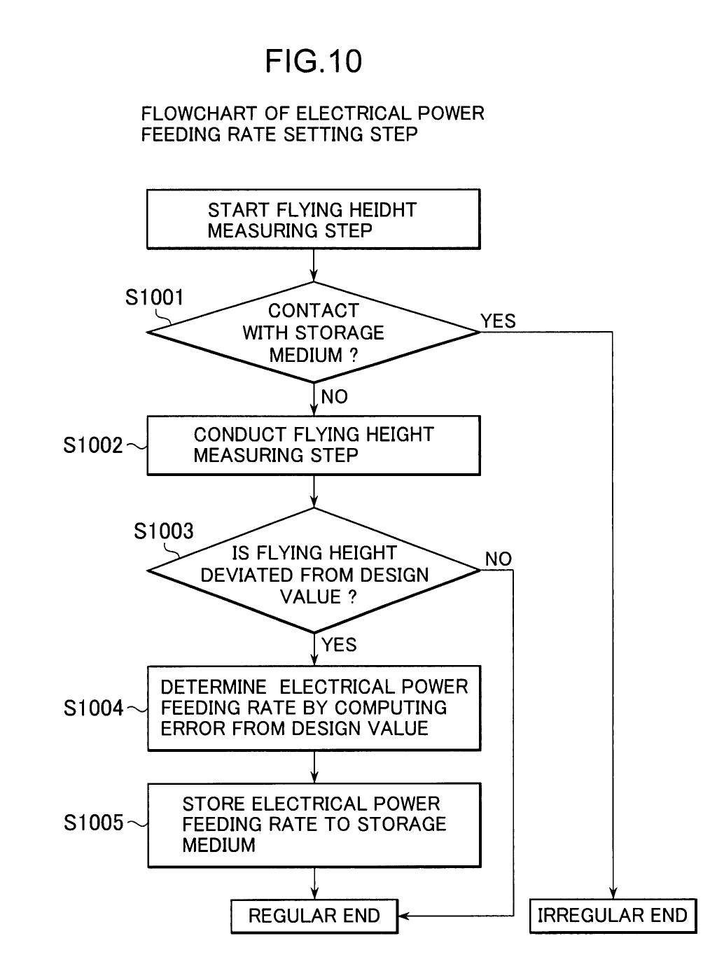

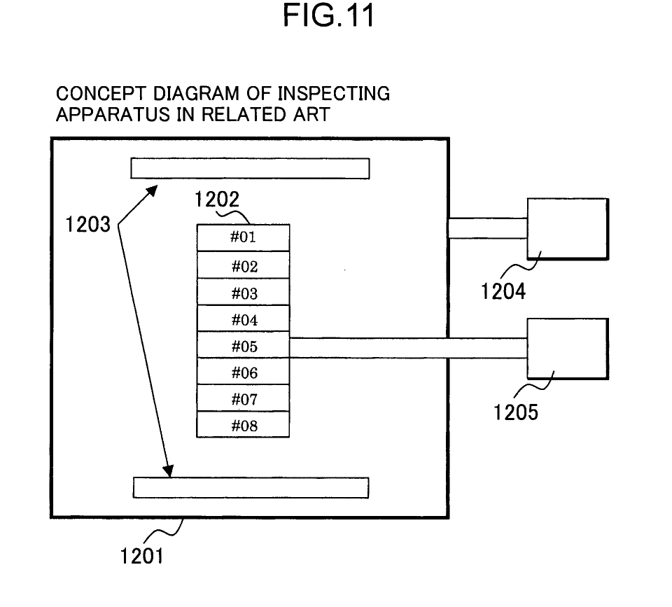

Next, another aspect of the present invention will be explained below. FIG. 9 is a structural diagram of an inspection apparatus of a floating head. FIG. 10 is a flowchart of the electrical power feeding rate setting step.

In this embodiment, the inspection apparatus of floating head is used in the final step after the assembling step of apparatus in the manufacturing steps of the magnetic disk drive.

In the manufacturing steps of the magnetic disk drive, an error is generated in manufacturing accuracy and mounting accuracy of each member. Therefore, the distance 904 between the head slider 903 and the storage medium 901 mounted to the spindle motor 902, namely the flying height of head slider generally includes a fluctuation within a certain range for each magnetic disk drive. Therefore, it is more desirable that the magnetic disk drive can be operated in the optimum state conforming to the design value where the error is removed than that the magnetic disk drive is used within the range of such fluctuation near the lower limit value or the upper limit value.

In FIG. 9, the inspecting apparatus 906 includes a communication unit 907. The communication unit receives a read signal or the like, outputted from the magnetic disk drive 900. This read signal is used to determine the distance between the head slider 903 and storage medium 901 or contact state thereof. The inspecting apparatus 906 also includes a memory 908 for storing the read signal, and a CPU 909 for determining distance 904 between the front end part of the head element of the head slider 902 and the front surface of the storage medium 901. The distance is determined by using the read signal. The CPU 909 also determines electrical power to the heat generating material when the magnetic disk drive is operating.

Meanwhile, the CPU 909 comprises processing functions or programs corresponding to a setting unit, a drive, control unit and an inspecting unit.

The setting unit sets the electrical power to the heat generating material. The heat generating material provides the fluctuation of the flying height of the floating head. The fluctuation of the flying height is determined in advance to each environment condition corresponding to the controller for inspecting the performance of floating head in accordance with the environmental condition.

The drive and control unit executes the drive and control of the head element (i.e. write and read operations) to the magnetic disk drive or floating head by feeding the electrical power corresponding to each environmental condition preset by the setting unit for the heat generating material, and executing the drive and control operation to the projecting state corresponding to each environmental condition by projecting the head element. An inspecting unit checks performance of the floating head by changing the projecting state with the drive and control unit. This inspecting apparatus 906 may be provided with a display unit 910 such as a display for outputting a series of the processing results and an input unit 911 such as a keyboard and a mouse.

The manufacturing method of magnetic disk drive for keeping constant the flying height 904 of head slider under the specified conditions will be explained hereunder. CPU 909 feeds superimposed electrical powers to the heat generating material in the feeding rate for emulating the flying height of head slider under the predetermined condition, for example, in the altitude of 3000 m and in the feeding rate for the write operation.

And then CPU 909 determines whether the front end part of head element is in contact with the front surface of the storage medium 901 during the operation (S1001). The concrete detecting method is identical to that explained in the first embodiment and the same explanation is omitted here.

Here, if contact state is detected, the relevant head slider 903 is determined as a defective one which cannot assure normal operations because necessary flying height is not obtained. Moreover, the suspension mechanism including defective head slider is exchanged or subjected to adjustment of spring pressure of the suspension mechanism. Accordingly, the only products having high performance floating heads are manufactured and a high quality storage device can also be provided.

Meanwhile, when contact state is not detected, it means that the flying height 904 assuring normal operation under the present environmental condition can be attained. The flying height under the present environmental condition is measured continuously (S1002). The flying height can be obtained, for example, with the method that the head element is set close to the storage medium by gradually increasing the electrical power to the heater 205, then read the data stored, and the electrical power at the change of the state of the read signal received via the communication unit 907.

Subsequently, CPU 909 computes (S1003) an error between the actual flying height of head slider obtained in the step explained above and the optimum flying height previously determined in the design stage. More specifically, a difference of +0.5 nm of respective values can be computed in the optimum state under this condition, for example, in the case where the optimum value of distance between the front end part of the head element of the head slider and the front surface of the storage medium in the operating condition is 3 nm and the detected value is 3.5 nm. Namely, it means that the head slider is uselessly levitated higher than the optimum value as much as 0.5 nm. Accordingly, such distance can be approximated to the optimum value by eliminating such difference.

Moreover, the distance between the area near the head element of head slider 903 and the front surface of storage medium 901 becomes larger than the optimum value when the write operation is executed. The electrical power is attained by superimposing the power to the heater on the predetermined power for write operation and that for read operation.

FIG. 5A suggests that the head element 202 of head slider 903 can further be projected easily by 0.5 nm toward the storage medium 901 with the electrical power feeding with addition of 10 mA. As explained above, the power for providing projection rate corresponding to a difference between the design value and the actual projection rate is determined. And this power is added or subtracted to or from the power to the write head element or heater during the write operation (S1004).

Moreover, the electrical power explained above or to be added or subtracted or the power feeding rate attained by adding or subtracting the power feeding rate determined with the method can be stored to the magnetic disk drive via the communication unit 907. The flying height can be controlled to the optimum value using the stored data. (S1005). Therefore, the distance between the head element and the front surface of the storage medium during the write operation can be set to the optimum value equal to the design value.

For storing of the result of computation to the magnetic disk drive, it is more desirable that such result is stored to an unused region or system region other than the user data region in the case where the result is stored to the storage medium 901. And such result can be stored to a non-volatile memory 117 shown in FIG. 1A or to the register of the control circuit not illustrated for feeding electrical power to the heat generating material.

Therefore, according to this aspect of the present invention, the projection rate of the head element can be controlled using, during the write operation, the result of computation of the electrical power in accordance with the flying height of the head slider by storing such result of computation to the storage medium. The write operation to the storage medium can be realized under the optimum state conforming to the design value without any influence of various errors in response to the mounting accuracy of the head slider in the manufacturing process of the magnetic disk drive.

For this purpose, unnecessary margin or the like can be deleted and low flying height of the head slider can be realized. As a result, further enlargement of capacity of the magnetic disk drive can be realized.

In addition, even when an external shock or vibration is added during use of the magnetic disk drive, risk of damaging the magnetic disk drive due to contact with the storage medium can be lowered because the distance between the head slider and the storage medium is set to the optimum state. Therefore, operation reliability of the magnetic disk drive can further be improved.

In above example, the magnetic disk drive has been explained but the embodiments of the present invention can also be applied to the storage device such as magneto-optic disk drive, magnetic disk drive, and thermo-magnetic disk drive using the floating head.

What is claimed is:

1. A method for manufacturing a floating head having a head element for writing or reading data to or from a storage medium, comprising:
setting an electrical power to a heat generating material to attain a flying height of the floating head predetermined for each environmental condition;
projecting the head element in accordance with each environmental condition by driving the head element and feeding electrical power to the heat generating material; and
inspecting performance of the floating head by changing the projecting condition.

2. The manufacturing method according to claim 1, wherein the environmental condition includes at least one of air pressure, temperature, or humidity.

3. The manufacturing method according to claim 1, wherein the head element includes a write element used to write data to the storage medium and the heat generating material includes the write element.

4. The manufacturing method according to claim 1, wherein the head element includes a heater and the heat generating material includes the heater.

5. The manufacturing method according to claim 3, the projecting step is further comprising:
driving the head element by feeding electrical power to the write element in the power feeding rate required in the write operation; and
projecting the head element by feeding electrical power to the write element in the feeding rate corresponding to each environmental condition.

6. The manufacturing method according to claim 4, wherein the projecting step further comprises:
driving the head element by feeding the electrical power to the write element in the power feeding rate required in the write operation; and
projecting the head element by feeding electrical power to the heater in the feeding rate during the write operation and corresponding to each environmental condition.

7. The manufacturing method according to claim 4, wherein the projecting step comprises:
driving the head element by feeding the electrical power to the write element in the power feeding rate required in the read operation; and
projecting the head element by feeding electrical power to the heater in the feeding rate during the read operation and corresponding to each environmental condition.

8. A manufacturing method of storage device comprising a floating head including a head element for writing or reading data to and from a storage medium, comprising:
setting an electrical power feeding rate to a heat generating material to attain a flying height of floating head predetermined for different environmental conditions;
projecting the head element in accordance with each environmental condition by driving the head element and feeding the electrical power feeding rate to the heat generating material; and
inspecting performance of the floating head by changing the projecting condition.

9. The manufacturing method according to claim 8, wherein the environmental condition includes any one of the air pressure, temperature, and humidity.

10. The manufacturing method according to claim 8, wherein the head element includes the write element used for writing data to the storage medium and the heat generating material includes the write element.

11. The manufacturing method according to claim 8, wherein the head element includes a heater and the heat generating material includes the heater.

12. The manufacturing method according to claim 10, wherein the projecting step further comprises:
driving the head element by feeding electrical power to the write element in the power feeding rate required in the write operation; and
projecting the head element by feeding electrical power to the write element in the feeding rate corresponding to each environmental condition.

13. The manufacturing method according to claim 11, wherein the projecting step further comprises:
feeding electrical power to the write element in the electrical power feeding rate during data writing operation to the storage medium; and
feeding electrical power to the heater in the power feeding rate during data writing operation to the storage medium and corresponding to each environmental condition.

14. The manufacturing method according to claim 11, the projecting step further comprising:
driving the head element by feeding the electrical power to the write element in the power feeding rate required in the write operation; and
projecting the head element by feeding electrical power to the heater in the feeding rate during the write operation and corresponding to each environmental condition.

15. The manufacturing method according to claim 8, the electrical power feeding rate of the heat generating material is determined on the basis of the performance obtained by the inspecting step and the power feeding rate is stored in the storage device.

16. An inspecting apparatus for inspecting performance of a floating head having a head element for writing and reading data to and from a storage medium, comprising:
a setting unit for setting an electrical power feeding rate to a heat generating material provided to the floating head to attain the floatation changing rate predetermined for each environmental condition;
a drive and control unit for driving and controlling the head element to the projecting condition corresponding to each environmental condition by driving and controlling the head element and feeding electrical power in the feeding rate corresponding to each environmental condition preset with the setting unit to the heat generating material; and
an inspecting unit for inspecting performance of the floating head by changing projecting condition with the drive and control unit.
